(19) United States
(12) Patent Application Publication
(10) Pub. No.: US 2006/0224381 A1
(43) Pub. Date: Oct. 5, 2006

(54) Detecting speech frames belonging to a low energy sequence

(75) Inventor: Jari Makinen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/099,408

(22) Filed: Apr. 4, 2005

(51) Int. Cl. G10L 19/12

(52) U.S. Cl. 704/223

(57) ABSTRACT

In order to enable a detection of speech frames belonging to a low energy sequence of a speech signal, it is proposed that a speech energy in a current speech frame is determined. Further, a speech energy level is estimated based on a speech energy in a plurality of speech frames. The determined speech energy in the current speech frame is scaled, if the estimated speech energy level deviates at least by a predetermined amount from a predetermined nominal speech energy level. Then, it can be decided that the current speech frame belongs to a low energy sequence, if the, potentially scaled, frame energy is lower than a predetermined low energy threshold value.

### FIELD OF THE INVENTION

The invention relates to a method for detecting speech frames belonging to a low energy sequence of a speech signal. The invention relates equally to encoding modules, to an electronic device and to a software program product.

### BACKGROUND OF THE INVENTION

Speech signals can be encoded for enabling an efficient transmission or storage of these speech signals. The encoding can be based on a single coding mode. Alternatively, it can be based on different coding modes, resulting in different bit rates of the encoded speech. In this case, the respectively appropriate coding mode can be selected based on current conditions. The encoded signal may be decoded again taking account of the coding mode employed for the encoding.

Well-known speech codecs, which are employed for packet based transmissions of speech, are the Adaptive Multi-Rate (AMR) speech codec and the Adaptive Multi-Rate Wideband (AMR-WB) speech codec.

The AMR speech codec was developed for Global System for Mobile communications (GSM) channels and Enhanced Data rates for GSM Evolution (EDGE) channels, whereas the AMR-WB speech codec was developed for Wideband Code Division Multiple Access (WCDMA) channels. In addition, the codecs can be utilized in packet switched networks. Aspects of the AMR speech codec are defined in the standards 3GPP TS 26.071 V6.0.0 (2004-12): “AMR Speech Codec; General description” and 3GPP TS 26.090 V6.0.0 (2004-12): “AMR Speech Codec; Transcoding Functions”, which are incorporated by reference herein. Aspects of the AMR WB speech codec are defined in the standards 3GPP TS 26.171 V6.0.0 (2004-12): “AMR Wideband Speech Codec; General description” and 3GPP TS 26.190 V6.0.0 (2004-12): “AMR Wideband Speech Codec; Transcoding Functions”, which are equally incorporated by reference herein.

The AMR codec samples incoming speech with a sampling frequency of 8 kHz. The AMR-WB speech codec samples incoming speech with a sampling frequency of 16 kHz. The sampled speech is then subjected to an encoding process.

Both codecs are based on the conventional Algebraic Code Excitation Linear Prediction (ACELP) technology. Both codecs are further multi-rate codecs, which are able to employ a plurality of independent coding modes. However, the codecs may also be operated using a variable rate scheme, in which the output bit rate is not fixed to a number of predetermined values but can be selected freely.

A voice activity detection (VAD) is used to lower the bit rate during silence periods by employing a discontinuous transmission (DTX) functionality in case the speech signal does not comprise an active voice signal. In addition, the AMR codec comprises eight active speech coding modes with bit-rates of 12.2, 10.2, 7.95, 7.40, 6.70, 5.90, 5.15 and 4.75 kbit/s, while the AMR WB codec comprises nine active speech coding modes with bit-rates of 23.85 23.05, 19.85, 18.25, 15.85, 14.25, 12.65, 8.85 and 6.60 kbit/s. Typically the AMR and AMR WB codecs select the codec mode based only on the network capacity and radio channel conditions. GSM radio networks utilize the codec mode selection to handle the channel fading and error bursts, whereas WCDMA networks rely on a fast power control and make use of the codec mode selection for controlling the capacity in the network.

The codec mode can be selected independently for each analysis speech frame, having a length of 20 ms, depending on the supported mode set.

For illustration, an AMR based mobile communication system is depicted in FIG. 1.

The system comprises a mobile station (MS) 10, a base transceiver station (BTS) 11 and a transcoder (TC) 12.

The mobile station 10 comprises a multi-rate speech encoder 101 and a multi-rate channel encoder 102. The multi-rate speech encoder 101 receives input speech. The signals output by the multi-rate channel encoder 102 are transmitted via an uplink radio channel 141 to the BTS 11. The mobile station 10 further comprises a multi-rate channel decoder 103 and a multi-rate speech decoder 104. The multi-rate channel decoder 103 receives signals from the BTS 11 via a downlink radio channel 142. The multi-rate speech decoder 104 provides a speech output. The mobile station 10 further comprises a link adaptation unit 105 with a downlink quality measurement component 106 and a mode request generator 107.

The BTS 11 comprises a multi-rate channel decoder 111, which receives signals from a mobile station 10 via the uplink radio channel 141. The signals output by the multi-rate channel decoder 111 are transferred via an A_{bis/ter} interface to the TC 12. The BTS 11 further comprises a multi-rate channel encoder 112, which receives an input from the TC 12 via the A_{bis/ter} interface. The signals output by the multi-rate channel encoder 112 are transmitted via the downlink radio channel 142 to the mobile station 10. The BTS 11 further comprises a link adaptation unit 113, including an uplink quality measurement component 114, an uplink mode control component 115 and a downlink mode control 116.

The TC 12 comprises a multi-rate speech decoder 121, which receives signals from the BTS 11 via the A_{bis/ter} interface, and which provides a speech output. The TC 12 further comprises a multi-rate signal encoder 122, which receives a speech input. The signals output by the multi-rate signal encoder 122 are transferred via the A_{bis/ter} interface to the BTS 11.

The uplink quality measurement component 114 of the BTS 11 performs quality measurements on received uplink signals and provides a corresponding quality indicator QIᵤ to the uplink mode control component 115. The uplink mode control component 115 receives in addition information about network constraints and determines a codec mode command MCᵤ. This command MCᵤ indicates a codec mode that should be employed by the mobile station 10 for encoding speech signals for uplink transmissions in view of the current uplink radio channel conditions and the current network capacity. The command MCᵤ is transmitted after a channel encoding by the multi-rate channel encoder 112 as an inband signaling to the mobile station 10, together with speech data S and a downlink codec mode indicator MI_{d}.

In the mobile station 10, the codec mode command MCᵤ is available at the output of the multi-rate channel decoder 103 and provided to the multi-rate speech encoder 101. The multi-rate speech encoder 101 uses thereupon the codec mode indicated by the command MCᵤ for encoding input speech signals on a frame basis. For the encoding, it detects whether any voice activity is present. If no voice activity is present, it uses a discontinued transmission. Otherwise, it computes linear prediction coding (LPC) coefficients and long term prediction (LTP) parameters, and performs a fixed codebook excitation search for obtaining a parametrical representation of the speech. The encoded speech S and an indication of the employed codec mode MIᵤ are then provided to the multi-rate channel encoder 102 for a channel encoding. Moreover, the downlink quality measurement component 106 performs quality measurements on received downlink signals and provides a corresponding quality indicator QI_{d} to the mode request generator 107. The mode request generator 107 determines based on the quality indicator QI_{d} a downlink codec mode request MR_{d}. This request MR_{d} is transmitted after a channel encoding by the multi-rate channel encoder 102 in an inband signaling to the BTS 11, together with speech data S and an uplink codec mode indicator MIᵤ.

In the BTS 11, the codec mode request MR_{d} is available again at the output of the multi-rate channel decoder 111 and provided to the downlink mode control 116, which receives in addition network constraint information as well. Based on the received information, the downlink mode control 116 determines a downlink codec mode command MC_{d}, which is then transferred via the A_{bis/ter} interface to the multi-rate speech encoder 122 of the TC 12. This command MC_{d} indicates a codec mode that should be employed by the TC 12 for encoding speech signals for downlink transmissions in view of the current downlink radio channel conditions and the current network capacity. The multi-rate speech encoder 122 thus uses the codec mode indicated by the command MC_{d} for encoding input speech signals, as outlined above for the multi-rate speech encoder 101, and outputs in addition to the encoded speech S a corresponding downlink codec mode indicator MI_{d}.

As becomes apparent, the rate adaptation is based exclusively on channel and network conditions. The speech signal itself is only evaluated for deciding on a discontinuous transmission. While a VAD driven discontinuous transmission is the most common approach for optimizing the network capacity based on the source signal, other perceptual criteria could be utilized to select the optimal codec mode during active speech. Current AMR and AMR-WB codec implementations in GSM and UMTS do not support such a source based rate adaptation, though, nor do they support an average bit rate control.

In a source based rate adaptation, the encoded speech sequence is classified into classes based on speech characteristics. Used speech classes can be, for example, low energy sequence, transient sequence, unvoiced sequence and voiced sequences. The codec mode which is to be employed may then be selected based as well on the detected speech class. For example, low energy sequences can be encoded with lower bit rates without any degradation in speech quality than other sequences. On the other hand, for example, during transient sequences the speech quality degrades very rapidly, if codec modes with a lower bit rate are used. The appropriate codec modes for voiced and unvoiced speech sequences depend on the frequency content of the sequences. For example, low frequency voiced sequence can be coded with a lower bit rate without speech quality degradation than high frequency voiced sequence. Usually noise-like unvoiced sequences requires a high bit rate representation.

Speech frames can be classified for a codec mode selection based on information that is already available in the speech encoder. Such information may comprise for instance already calculated values, which are obtained from VAD, LPC and LTP routines, like spectral content, LTP and fixed codebook gains of previous speech frames, etc. Therefore, a source adaptation algorithm may be rather simple and not increase the complexity of the encoding process substantially.

A source based rate adaptation is currently used for example in IS-95 CDMA networks, in which the Enhanced Variable Rate Codec (EVRC) is used as a source controlled variable rate codec. The EVRC selects the bit-rate of the encoded parameters before encoding the signal. In an exemplary EVRC implementation, the source based rate adaptation is performed based on the input signal and on LPC filter parameters, before the quantization of the filter parameters as well as before the search for LTP filter parameters and for an excitation signal. In the source based rate adaptation of the EVRC, the frame energy is calculated in two frequency bands and compared to thresholds for a mode selection. The thresholds are updated using background noise estimates and an autocorrelation function from the LPC analysis. Hence, the rate is selected using the reflection coefficients of the LPC analysis and input signal before the encoding functions. The EVRC has been described for instance in the document IS-127: “Enhanced Variable Bit Rate Codec, Speech Service option 3 for Wideband spread spectrum digital systems”.

In general, a source controlled variable rate operation aims at reducing the average source bit rate without any perceptual degradation in the decoded speech quality. The advantage of a lower average bit rate is a lower transmission power and hence a higher capacity in the networks. A reduced bit rate also results in a smaller storage size in a voice recording application.

FIG. 2 is a diagram depicting the energy of a speech sequence over time and in addition a possible source adaptation exploiting codec modes with 6.60 kbit/s, 12.65 kbit/s and 23.05 kbit/s in addition to a discontinuous transmission mode. It can be seen from FIG. 2 that a considerable bit rate reduction can be achieved by coding low energy sequences with 6.60 kbit/s. The usage of discontinuous transmission (DTX) is not possible during such low energy sequences, because a discontinuous transmission may cause audible speech clipping.

However, the absolute speech quality will degrade as a function of the bit-rate in a multi-rate speech codec. This is especially true, when strong environmental noise, for instance in a car, on the street or in a cafeteria, is present during a call. It is thus a problem, if the low energy threshold has been set by too high value and the low bit rate mode is used more frequently than appropriate.

J. Mäkinen and J. Vainio propose in the conference paper: “Source signal based rate adaptation for GSM AMR speech codec”, Proc ITCC 2004, Las Vegas, USA, 2004, to scale the low energy threshold based on an estimate of a long-term energy level of the speech.

### SUMMARY OF THE INVENTION

It is an object of the invention to enable a reliable determination whether a speech frame belongs to a low energy sequence of a speech signal.

It is also an object of the invention to provide an alternative to existing approaches for determination of whether a speech frame belongs to a low energy sequence of a speech signal.

A method for detecting speech frames belonging to a low energy sequence of a speech signal is proposed. The method comprises determining a speech energy in a current speech frame. The method further comprises estimating a speech energy level based on a speech energy in a plurality of speech frames. The method further comprises scaling the determined speech energy in the current speech frame, if the estimated speech energy level deviates at least by a predetermined amount from a predetermined nominal speech energy level. The method further comprises deciding that the current speech frame belongs to a low energy sequence, if the, potentially scaled, frame energy is lower than a predetermined low energy threshold value.

Moreover, an encoding module is proposed, which comprises a frame energy detector adapted to determine a speech energy in a current speech frame of a speech signal. The electronic device further comprises a speech level estimator adapted to estimate a speech energy level based on a speech energy in a plurality of speech frames. The electronic device further comprises a scaling portion adapted to scale a speech energy in a current speech frame determined by the frame energy detector, if a speech energy level estimated by the speech level estimator deviates at least by a predetermined amount from a predetermined nominal speech energy level. The electronic device further comprises a selector adapted to decide that the current speech frame belongs to a low energy sequence, if a, potentially scaled, frame energy provided by the scaling portion is lower than a predetermined low energy threshold value.

Moreover, an encoding module is proposed, which comprises in general means for determining a speech energy in a current speech frame of a speech signal, means for estimating a speech energy level based on a speech energy in a plurality of speech frames, means for scaling a speech energy in a current speech frame determined by the frame energy detector, if a speech energy level estimated by the speech level estimator deviates at least by a predetermined amount from a predetermined nominal speech energy level, and means for deciding that the current speech frame belongs to a low energy sequence, if a, potentially scaled, frame energy provided by the scaling portion is lower than a predetermined low energy threshold value.

Moreover, an electronic device is proposed, which comprises at least the same features as one of the proposed encoding modules.

Finally, a software program product is proposed, in which a software code for detecting speech frames belonging to a low energy sequence of a speech signal is stored. When running in a processing unit of an electronic device, the software code realizes the steps of the proposed method.

The invention proceeds from the consideration that the optimal low energy threshold for determining whether a speech frame belongs to a low energy sequence or not depends on the speech energy level. The term speech energy level denotes the average energy level of active speech over a longer time period, for instance during one to five seconds. The optimal low energy threshold can be found easily, if the energy level of speech remains constant. However, that is an ideal case. In practice, the speech energy level varies for instance from one conversation to another and also during a single conversation. Even during a single, long sentence, the speech energy level may vary considerably.

In order to take account of variations in the speech energy level, the low energy threshold could be adapted based on an estimate of a long-term energy level of the speech, as proposed in the above cited document by J. Makinen and J. Vainio.

The invention proposes instead that the speech energy in the current speech frame, which will also be referred to as frame energy, is scaled depending on deviations of a speech energy level estimate from a predetermined nominal speech energy level. Thereby, the scaled frame energy can be kept independent of the current general speech level and, consequently, it can always be compared to a fixed low energy threshold.

It is an advantage of the invention that it enables a reliable association of speech frames to low energy sequences. The invention may thus be used for optimizing the speech codec mode selection in a source based rate adaptation. By an improved basis for a speech codec mode selection, a more efficient source based rate adaptation can be achieved, and thus a better and more constant compromise between the contrasting requirements of a low bit rate and a high speech quality.

In one embodiment of the invention, the speech energy in the current speech frame is determined by averaging speech energies in a plurality of frequency sub bands in the current speech frame.

In a further embodiment of the invention, only those speech frames are considered as a basis for determining the speech energy level, in which a voice activity has been detected, since only the active speech may contribute to the speech energy level.

In a further embodiment of the invention, the speech energy level is updated for a respective current speech frame by combining a speech energy level available for a speech frame preceding the current speech frame with the speech energy determined for the current speech frame with variable coefficients, wherein a coefficient for the speech energy determined for the current speech frame may be equal to zero.

The combining can be carried out in various ways and taking account of various criteria.

For example, in case the determined speech energy in the current speech frame is higher than a speech energy in the preceding speech frame, the available speech energy level may be weighted with a first coefficient. In case the determined speech energy in the current speech frame is lower than the speech energy in the preceding speech frame, the available speech energy level may be weighted with a second coefficient. The first coefficient is then advantageously higher than the second coefficient. The coefficient for the speech energy determined for the current speech frame may be adapted for example in an opposite manner.

In addition, different coefficients may be selected for speech frames at the beginning of a respective speech signal than for speech frames at a later stage. The difference between the first coefficient for the available speech energy level and the second coefficient for the available speech energy level may in particular be larger for a predetermined number of speech frames at a beginning of a respective speech sequence. Thereby, a more aggressive adaptation can be achieved at the beginning of a speech sequence, at which only a few speech frames are available for determining the speech energy level.

For the very first speech frame, for example simply the energy of this first speech frame could be used as the speech energy level. Alternatively, the nominal speech energy level could be considered as the speech energy level which is available for a theoretical preceding speech frame.

In a further embodiment of the invention, the speech energy level is only updated, in case the updated speech energy level exceeds a background noise estimate for the current speech frame by a predetermined factor.

Advantageously, the frame energy is scaled to the nominal speech level. That is, in case the estimated speech energy level exceeds the nominal speech level at least by a predetermined amount, the determined speech energy for the current frame is scaled to a lower value, while in case the estimated speech energy level falls short of the nominal speech level at least by a predetermined amount, the determined speech energy for the current frame is scaled to a higher value.

In one embodiment of the invention, the scaling is performed based on one of a plurality of correction functions. Each correction function is valid for another range of speech energy levels. Using a plurality of predetermined correction functions makes the implementation of the scaling easier than the use of a correction function that is adapted exactly for each occurring speech energy level. It is to be understood that the plurality of predetermined correction functions may be based on a single correction function including different coefficients. Such coefficients can be stored for instance in the form of a matrix, from which they are retrieved depending on the respective speech energy level.

In one embodiment of the invention, the scaling comprises at least a multiplication of the speech energy in the current speech frame by a selected value and an adding of a selected value. The values may constitute the coefficients of a correction function and be selected depending on the speech energy level.

The invention can be employed for instance in the scope of a speech coding. The current speech frame may be encoded with a dedicated low bit rate coding mode in case it is detected to belong to a low energy sequence. Encoding low energy sequences with a lower rate codec mode than higher energy sequences may contribute significantly to a decrease of the average bit rate. If the low energy sequences are further detected in a flexible way, as proposed, a speech quality degradation due to a too high low energy threshold can be avoided.

The low energy sequence detection can be performed before an encoding of the current speech frame or during an encoding of the current speech frame.

In AMR-WB modes from 12.2 kbit/s to 23.85 kbit/s, for example, the only difference in the encoding process is the fixed codebook excitation search. Lower modes, like the 12.2 kbit/s mode, use less pulses for excitation than higher modes, like the 23.85 kbit/s mode. The 23.85 kbit/s has also a high frequency extension gain parameter, which is calculated after the fixed codebook excitation search. For these modes, a source base rate adaptation could be performed during the encoding process before the fixed codebook excitation search. The lowest AMR-WB modes, 6.60 kbit/s and 8.85 kbit/s, in contrast, have a different LPC and LTP parameter representation. If these modes are considered as an option in a source based rate adaptation, the source based rate adaptation has to be performed at the beginning of encoding process before the calculation and quantization of the LPC and the LTP parameters. The mode selection can be performed more accurately, if it is carried out during the encoding process. In this case, the mode selection can exploit as well information about the current frame, that is, basically LPC and LTP information of the current encoded frame, in addition to information history.

The invention can be employed for example, though not exclusively, for a source based rate adaptation in AMR or AMR-WB speech codecs used in GSM and WCDMA communication systems. It can further be used for variable and multi-rate speech coding. It can be employed for example for the transmission of encoded speech over erroneous and capacity limited transmission channels, in both, circuit switched and packet switched domains.

Each of the proposed electronic devices can be for example a device comprising a speech encoder, in particular any device adapted to transmit or to store speech data. It can be for instance a mobile communication device or a network element of a mobile communication network, etc.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a conventional communication system;

FIG. 2 is a diagram illustrating data rates employed in an adaptive rate coding for an exemplary speech sequence;

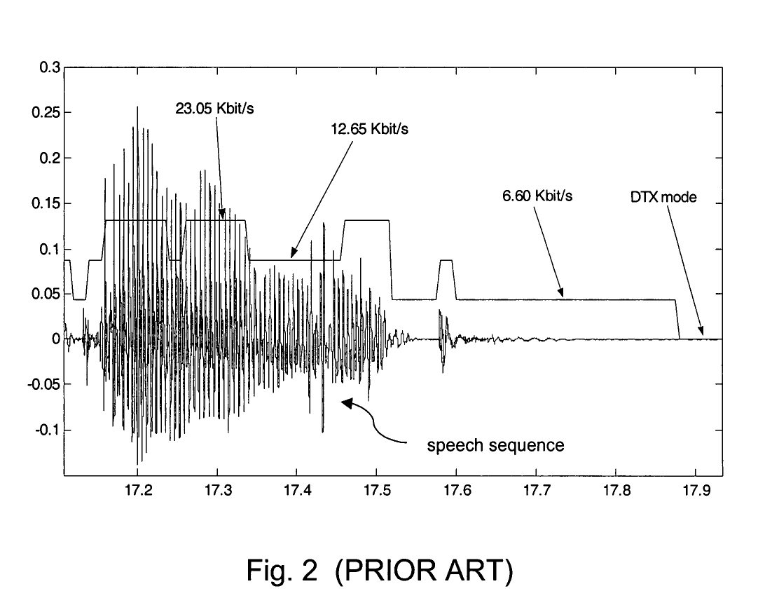

FIG. 3 is a schematic block diagram of a mobile station which can be implemented in accordance with an embodiment of the invention;

FIG. 4 is a schematic block diagram of a processing unit of the mobile station of FIG. 3 operating in accordance with an embodiment of the invention;

FIG. 5 is a flow chart illustrating a source based coding mode selection according to an embodiment of the invention;

FIG. 6 is a diagram presenting the same speech sequence at different speech levels;

FIG. 7 is a diagram illustrating energy level estimates of the same speech sequence for different speech levels; and

FIG. 8 is a diagram illustrating a scaling of the frame energy in accordance with an embodiment of the invention.

### DETAILED DESCRIPTION OF THE INVENTION

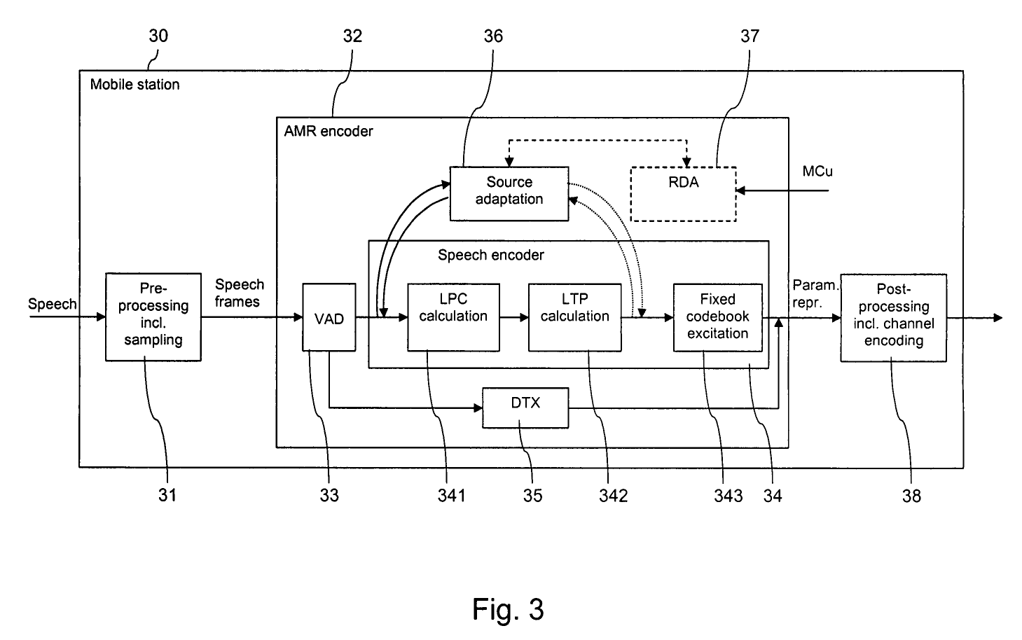

FIG. 3 is a block diagram of a mobile station 30 that has been implemented according to an embodiment of the invention, in order to enable an enhanced source based coding mode selection.

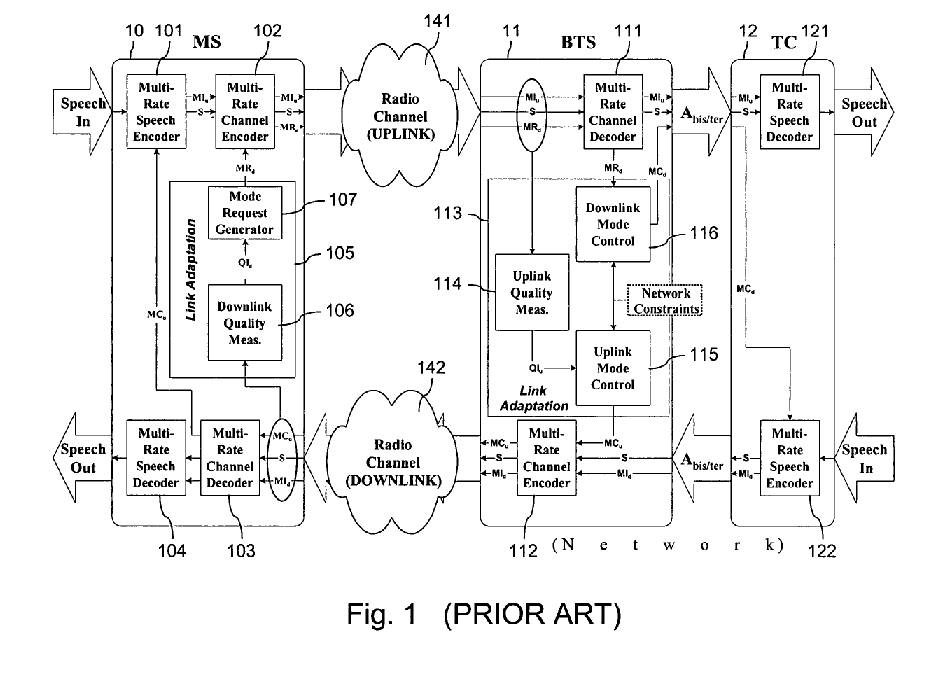

The mobile station 30 can be a part of a communication system like the one that has been described above with reference to FIG. 1. It may comprise the same structure of a receiving chain, a transmitting chain and a link adaptation portion. FIG. 3 presents only selected parts of this transmitting chain.

A speech input (not shown) of the mobile station 30, for instance a microphone, is connected via a pre-processing component 31, an AMR encoder 32 and a post-processing component 38 to an output of the mobile station 30, for instance a transmit antenna (not shown).

The pre-processing component 31 is designed to perform all processing preceding the AMR encoding of input speech, including for instance a sampling and quantization step (i.e., analog-to-digital conversion). The post-processing component 38 is designed to perform all processing following the AMR encoding of input speech that is required for a transmission via the radio interface, including for instance a channel encoding. That is, the post-processing component 38 may comprise at least the multi-rate channel encoder 102 of the mobile station 10 of FIG. 1.

The AMR encoder 32 can be a modification of the multi-rate speech encoder 101 of the mobile station 10 of FIG. 1.

The input of the AMR encoder 32 is connected to a voice activity detector (VAD) 33. A first output of the VAD 33 is connected via a speech encoder 34 to the output of the AMR encoder 32. A second output of the VAD 33 is connected via a discontinous transmission (DTX) component 35 to the output of the AMR encoder 32.

Within the speech encoder 34, an LPC (linear prediction coding) calculation component 341, an LTP (long term prediction) calculation component 342 and a fixed codebook excitation component 343 are connected in sequence between the input and the output of the speech encoder 34.

The AMR encoder 32 further comprises a source adaptation component 36 which is designed according to an embodiment of the invention. The source adaptation component 36 is arranged to access the speech encoder 34 either at its input or between the LTP calculation component 342 and the fixed codebook excitation component 343. Optionally, the source adaptation component 36 may further interact with an additional rate determination algorithm (RDA) 37.

It has to be noted that the mobile station 30 of FIG. 3 may correspond entirely to a conventional mobile station, like a mobile phone, except for the source adaptation component 36, which is modified in accordance with the invention.

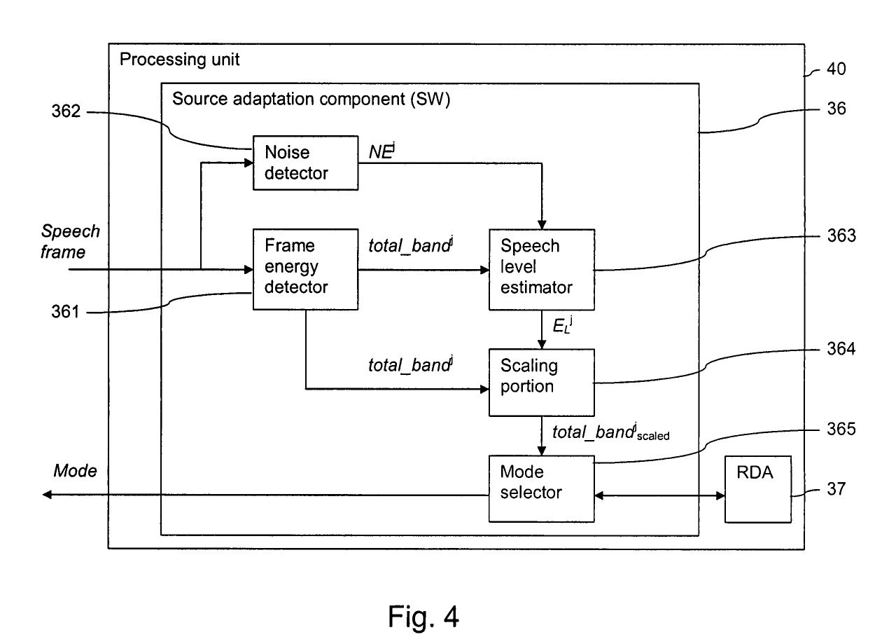

FIG. 4 is a schematic block diagram, which presents in particular in more detail parts of this modified source adaptation component 36.

The source adaptation component 36 may be realized in software (SW), as shown, which can be executed by a processing unit 40 of the mobile station 30. The processing unit 40 may be a dedicated processing unit or a processing unit that is adapted to execute various software codes implemented in the mobile station 30, including for example any software code for other components of the AMR encoder 32, like the additional rate determination algorithm 37.

A speech frame input of the source adaptation component 36 is linked to a frame energy detector 361 and to a noise estimator 362. The output of the frame energy detector 361 and the output of the noise estimator 362 are linked to an input of a speech level estimator 363. The output of the frame energy detector 361 is linked in addition to an input of a scaling portion 364. The output of the speech level estimator 363 is equally linked to an input of the scaling portion 364. The output of the scaling portion 364 is linked to a mode selector 365. The mode selector 365 may interact with the rate determination algorithm 37. The output of the mode selector 365 forms the output of the source adaptation component 36.

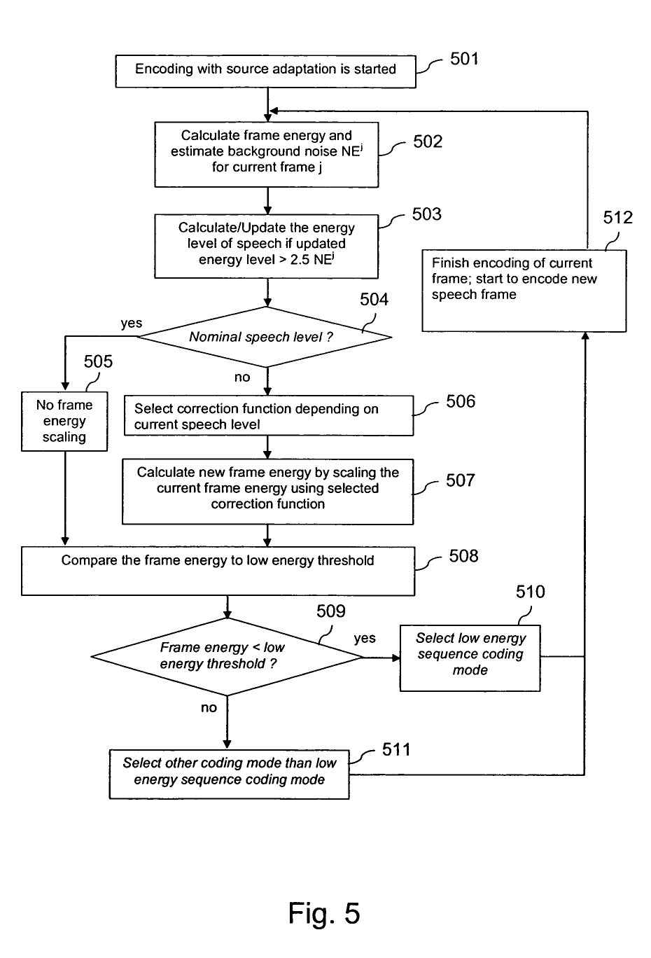

The operation of the mobile station 30 in accordance with an embodiment of the invention will now be described with reference to the flow chart of FIG. 5.

When a speech signal, which is received by the mobile station 30 for instance via a microphone, is to be transmitted to a mobile communication network, an encoding with source adaptation is started (step 501).

The actual encoding of the speech signal is performed in a conventional manner. That is, the speech signal is first pre-processed by the pre-processing component 31, including a sampling and quantization of the speech signal, etc. Resulting speech frames are provided to the AMR encoder 32.

The VAD 33 of the AMR encoder 32 then detects for each speech frame whether there is any voice activity in the signal.

If no voice activity detected in the current speech frame, a discontinuous transmission is taken care of by the DTX component 35. The signal is then provided directly to the post processing component 38.

If a voice activity detected in the current speech frame, the frame is input to the speech encoder 34 and in addition to the source adaptation component 36.

In the source adaptation component 36, the frame energy detector 361 detects the frame energy total_band^{j} of the current speech frame j, while the noise estimator 362 estimates the background noise NE^{j} for the current speech frame j (step 502).

The frame energy total_band^{j} of the current speech frame is a total band energy corresponding to the average of the energy in the speech frame over various sub bands. It is calculated as follows:

$${total\_band}^{j} = \frac{{\sum }_{i = 1}^{m} ( vad\_filt {\_band}_{i}^{j} )}{m} ,$$

where vad_filt_bandᵢ^{j} is the energy level of i^{th} band of the available sub bands in j^{th} speech frame, and where m is the number of available sub bands in the total frequency band.

The available sub bands can be taken for example from the following table, in which the total frequency band has been divided into m=12 sub bands, similarly as known from the VAD algorithm described in the standards 3GPP TS 26.093 V6.0.0 (2003-03): “AMR Speech Codec; Source Controlled Rate operation”, which is incorporated by Reference herein.

| Sub band number | Frequencies | |
|---|---|---|
| 1 | 0-200 | Hz |
| 2 | 200-400 | Hz |
| 3 | 400-600 | Hz |
| 4 | 600-800 | Hz |
| 5 | 800-1200 | Hz |
| 6 | 1200-1600 | Hz |
| 7 | 1600-2000 | Hz |
| 8 | 2000-2400 | Hz |
| 9 | 2400-3200 | Hz |
| 10 | 3200-4000 | Hz |
| 11 | 4000-4800 | Hz |
| 12 | 4800-6400 | Hz |

The noise estimator 362 estimates the background noise NE^{j} in the j^{th} speech frame as follows:

$${NE}^{j} = \frac{{\sum }_{i = 1}^{m} ( {bckr\_est}_{i}^{j} )}{m} ,$$

where the variable bckr_estᵢ^{j} is the background noise estimate of i^{th} sub band in the j^{th} speech frame. The calculation of the background noise estimate as such is well known and can be performed for example as described in the above mentioned standard TS 26.093 and in the further standard 3GPP TS 26.193 V6.0.0 (2004-12): “AMR Wideband Speech Codec; Source Controlled Rate operation”, the latter being equally incorporated by reference herein.

The detected frame energy total_band^{j} and the estimated background noise NE^{j} for the current speech frame j are both forwarded to the speech level estimator 363. The frame energy total_band^{j} for the current speech frame j is forwarded in addition to the scaling portion 364.

Next, the speech level estimator 363 calculates or updates a long term energy level E_{L}^{j} of the speech, which is valid for the current speech frame j. The energy level estimate is determined only during speech segments for which the discontinuous transmission is off, in order to calculate the energy level estimate for the active speech level (step 503).

Only for the first speech frame of the speech sequence, the energy level estimate E_{L}^{j} is calculated. That is, for this first speech frame, the energy level estimate is simply set equal to the frame energy total_band¹ of the first speech frame, which is provided by the frame energy detector 361. For any subsequent speech frame j, the energy level estimate E_{L}^{j-1} determined for the respective preceding speech frame j−1 is updated to obtain the energy level estimate E_{L}^{j} for the current speech frame j.

An update of the energy level estimate E_{L}^{j} for the j^{th} speech frame in the speech level estimator 363 according to an embodiment of the invention will now be described.

A flag BOS is used for indicating the beginning of a speech segment as follows:

$$BOS = \{ \begin{matrix}1 , & {C}_{activity} < 0 \\ 0 , & {C}_{activity} \geq 0\end{matrix}$$

where C_{activity} is a counter having the initial value of 100. For the first 100 speech frames of the speech segment, the counter C_{activity} is decremented by one with each new speech frame for which a frame energy value is received:

$${C}_{activity} = \{ \begin{matrix}0 , & {C}_{activity} < 0 \\ {C}_{activity} - 1 , & {C}_{activity} \geq 0\end{matrix}$$

The counter C_{activity} thus has a value of zero after the first 100 speech frames of a new speech segment have been received. This enables a differentiation between the beginning of a speech segment and a later stage of a speech segment when updating the energy level estimate.

In addition, the updating differentiates between the cases that the frame energy total_band^{j} of the current speech frame j is higher or lower than the frame energy total_band^{j-1} of the preceding speech frame j−1.

The update is performed as follows:

$${E}_{L}^{j} = \{ \begin{matrix}{E}_{L}^{j - 1} , & BOS = 0 and {total\_band}^{j} > {total\_band}^{j - 1} \\ 0.95 * {E}_{L}^{j - 1} + 0.05 * {total\_band}^{j} , & BOS = 0 and {total\_band}^{j} \leq {total\_band}^{j - 1} \\ 0.999 * {E}_{L}^{j - 1} + 0.001 * {total\_band}^{j} , & BOS = 1 and {total\_band}^{j} > {total\_band}^{j - 1} \\ 0.992 * {E}_{L}^{j - 1} + 0.008 * {total\_band}^{j} , & BOS = 1 and {total\_band}^{j} \leq {total\_band}^{j - 1}\end{matrix}$$

where E_{L}^{j} is the energy level estimate of current speech frame j and E_{L}^{j-1} is the energy level estimate of previous speech frame j−1.

The impact of the frame energy total_band^{j} of the current speech frame j is thus lower, when the frame energy total_band^{j} of the current speech frame j is higher than the frame energy total_band^{j-1} of the preceding speech frame j−1 as compared to when the frame energy total_band^{j} of the current speech frame j is lower than or equal to the frame energy total_band^{j-1} of the preceding speech frame j−1. Further, the energy level estimate adapts more aggressively at the beginning of a speech sequence. Therefore the correct speech level estimation can be calculated faster, even if the speech sequence is short.

The updated energy level estimate E_{L}^{for j}^{th} speech frame is only used, however, if the estimate E_{L}^{j} lies clearly above the provided background noise estimate NE^{j}, for instance when E_{L}^{j}>2.5*NE^{j} (step 503). Otherwise, the energy level estimate E_{L}^{j-1} for the previous speech frame j−1 is used as well as the energy level E_{L}^{j} for the current speech frame j.

The energy level estimate E_{L}^{j} for the current speech frame j is then provided to the scaling portion 364 for performing a scaling of the frame energy total_band^{j} provided by the frame energy detector 361, if required.

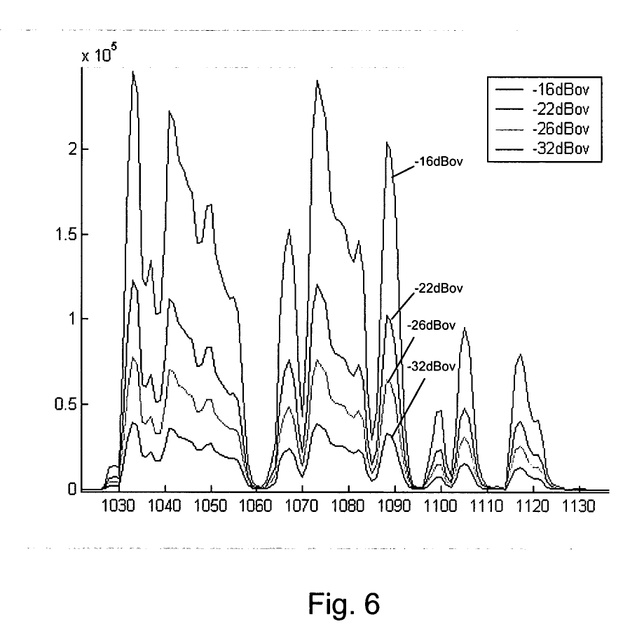

FIG. 6 is a diagram illustrating the frame energies for the same speech sequence with four different speech energy levels, namely −16 dBov, −22 dBov, −26 dBov and −32 dBov. The respective frame energies total_band^{j} in [dBov] are depicted roughly over speech frames j=1030 to 1130, indicated on the x-axis. As can be seen from FIG. 6, the frame energy varies significantly from frame to frame.

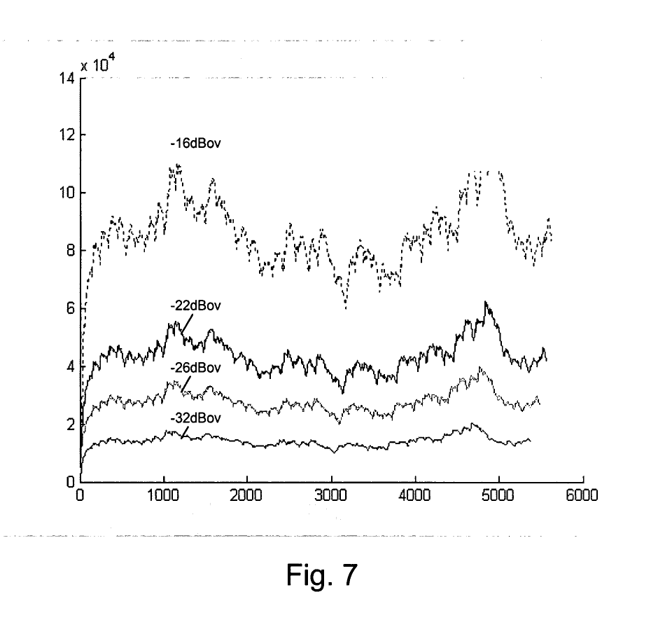

FIG. 7 is a diagram illustrating the energy levels E_{L}^{j} in [dBov] estimated for the four speech sequences of FIG. 6, with the respective speech frame j=1 to 6000 indicated on the x-axis.

In order to eliminate the impact of a deviation of the speech energy level from a nominal speech level onto the frame energy, the scaling portion 364 scales the frame energy into a nominal speech level set to approximately −26 dBov.

The scaling portion 364 determines to this end first whether the energy level estimate E_{L}^{j} for the current speech frame j is close to the nominal speech level (step 504).

If the energy level E_{L}^{j} is close to the nominal speech level, no frame energy scaling is performed. Instead, the frame energy is provided directly to the mode selector 365 (step 505).

If the energy level E_{L}^{j} is not close to the nominal speech level, in contrast, a correction function for scaling the frame energy is selected, depending on the difference between the nominal energy level and the energy level estimate E_{L}^{j} for the current speech frame j. The correction function is selected such that if the energy level is lower than the nominal energy level, the frame energy is scaled upwards, and if the energy level is higher than the nominal energy level, the frame energy is scaled downwards (step 506).

A new frame energy is then calculated by applying the determined correction function, and the scaled frame energy is provided to the mode selector 365 (step 507).

The following algorithm is a simple example for realizing steps 504 to 507:

As long as the flag BOS is equal to one (BOS=1), that is, at the beginning of a speech sequence, no scaling is performed. If the flag BOS is equal to zero (BOS=0), the following algorithm is performed:

/* If energy level estimate < −28dBov */
if (E_{L} < Energy_Level[1])

/* If −32dBov < energy level estimate < −28dBov*/
if E_{L} > Energy_Level [0]

i = 3

/* If energy level estimate < −32dBov */
else

i = 4

| /* Frame energy is scaled towards nominal level*/ | |
|---|---|
| total_band_{Scaled} = | M[i][2]*total_band*total_band + |

M[i][1]*total_band + M[i][0]

/* If energy level estimate > −24dBov */
else if E_{L} > Energy_Level[2]

/* If −18dBov > energy level estimate > −24dBov*/
if E_{L} < Energy_Level[3]

i = 2

/* If energy level estimate > −18dBov*/
else

i = 1;

| /* Frame energy is scaled towards nominal level*/ | |
|---|---|
| total_band_{Scaled} = | M[i][2]*total_band*total_band + |

M[i][1]*total_band + M[i][0].

The frame energy total_band is thus scaled by using a second order equation (a*x²+b*x+c) as follows:
total_band_{scaled}=(M(i,3))*total_band²+M(i,2)*total_band+M(i,1),
where M is a matrix including the coefficients for the scaling equation. The indices 1, 2 and 3 point to the first, second and third column, respectively, of the matrix. The index i points to a respective row of the matrix, the value of i depending on the energy level estimate E_{L}^{j} for the current speech frame j.

An exemplary scaling matrix M is give by:

$$M = [ \begin{matrix}\text{-} 2.3740 , & 0.3161 , & \text{-} 0.2863 \\ \text{-} 1.2955 , & 0.6309 , & \text{-} 0.0004 , \\ 1.4239 , & 1.4527 , & 0.3637 , \\ 2.7193 , & 1.7620 , & 0.4832\end{matrix} ]$$

The first row of the matrix M, used for i=1, includes the coefficients for a speech level exceeding −18 dBov. The second row of the matrix M, used for i=2, includes the coefficients for a speech level between −18 dBov and −24 dBov. The third row of the matrix M, used for i=3, includes the coefficients for a speech level between −32 dBov and −28 dBov. The fourth row of the matrix M, used for i=4, includes the coefficients for a speech level falling short of −32 dBov. No scaling is performed, when the energy level estimate E_{L}^{j} lies between −24 dBov and −28 dBov, that is, in case it lies around the nominal level of −26 dBov.

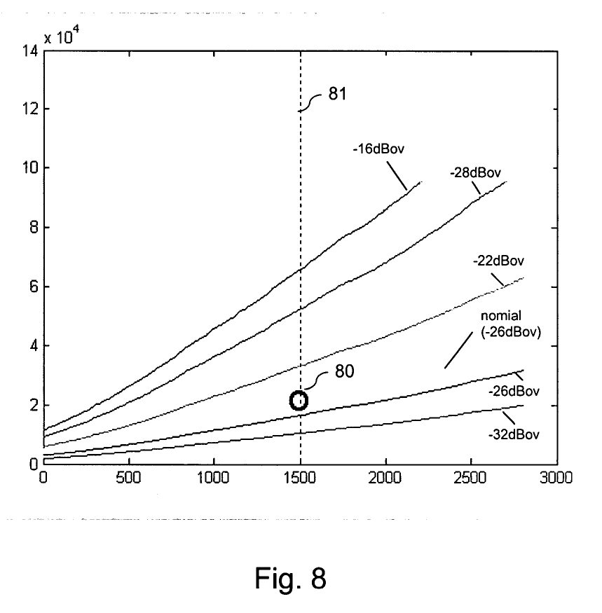

FIG. 8 is a diagram illustrating the scaling, in which the y-axis describes an amount of energy and in which the x-axis indicates the number of frames. Five curves are depicted for a speech sequence having a speech energy level of −16 dBov, −28 dBov, −22 dBov, −26 dBov and −32 dBov, respectively. For each speech energy level, the speech frames have been sorted to have ascending frame energies. In addition, a curve representing the nominal speech energy level of approximately −26 dBov is indicated. According to the presented embodiment of the invention, the frame energies are scaled to a nominal speech level around −26 dBov by exploiting the correction functions designed for each speech level. The frame energies of the curve having a speech energy level of −26 dBov are not scaled, because they are very close to the frame energies of the nominal speech level. Once the correction function specified for each speech level has been applied to the frame energies of the other four curves, the frame energies of these curves are scaled towards the frame energies of the curve for the nominal speech energy level.

The mode selector 365 compares the, potentially scaled, frame energy with a low energy threshold. Since the frame energy is scaled depending on the energy level estimate for the speech frame, it is independent of the general speech energy level, and it can be compared to a fixed low energy threshold (step 508).

More specifically, the mode selector 365 has an threshold vector Energy_Level:

$$Energy\_Level = [ \begin{matrix}A \\ B \\ C \\ D\end{matrix} ] ,$$

where A, B, C and D are various energy level thresholds. In the above presented algorithm, for example, these thresholds are A=energy level[0]=−32 dBov, B=energy level[1]=−28 dBov, C=energy level[2]=−24 dBov and D=energy level[3]=−18 dBov.

If the scaled frame energy total_band_{Scaled} is smaller than the low energy threshold (step 509), a low energy sequence is detected and a low rate coding mode is selected (step 510).

If the scaled frame energy total_band_{Scaled} is larger than the low energy threshold (step 509), a low energy sequence is not detected, and a further adaptation algorithm is called for determining the appropriate coding mode (step 511). The further adaptation algorithm can be for example the rate detection algorithm 37. The rate detection algorithm 37 may receive as well uplink codec mode commands (MCᵤ) from the mobile communication network embedded in received signals, as indicated above with reference to FIG. 1.

The mode selector 365 then provides the selected coding mode to the speech encoder 34, which finishes the encoding of the current frame j making use of the selected coding mode. The encoding comprises a calculation of LP coefficients in the LPC calculation component 341, a calculation of LTP parameters in the LTP calculation component 342 and a determination of fixed codebook parameters for an LPC excitation. As known from a conventional coding mode selection, it depends on the selected mode the processing of which portions 341, 342, 343 of the speech encoder are affected (step 512).

For the respected next frame j+1, steps 502 to 512 are repeated in a loop, until the speech sequence has been encoded completely for transmission.

In practice, the low energy threshold A should be tuned to the point, where the information content of the signal starts to increase dramatically.

In FIG. 8, a ring 80 indicates the point where the information content is dramatically increased in the case of a nominal speech energy level, and which is thus selected as the low energy threshold. If the frame energies of the −16 dBov speech level, for example, are not scaled and the low energy threshold for the nominal speech energy level is employed nevertheless, a short low energy sequence is detected and hardly any bit rate reduction is achieved, because most of the low energy sequence is encoded by a higher bit rate. On the other hand, if the frame energies of the −32 dBov speech level, for example, are not scaled and the low energy threshold for the nominal speech energy level is employed nevertheless, a very long low energy sequence is detected and it is encoded by lower bit rates. Obviously a considerable bit rate reduction can be achieved, but it also degrades the speech quality dramatically. Due to the scaling to the nominal speech energy level, in contrast, the low energy threshold for the nominal speech energy level is suitable for all speech energy levels. A vertical dashed line 81 through ring 80 shows the effective low energy thresholds which is applied for the various original speech energy levels.

It is to be understood that the source based rate adaptation presented for a mobile station 30 could equally be implemented in other electronic devices, for instance, in the multi-rate speech encoder 122 of the transcoder 12 of FIG. 1.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for detecting speech frames belonging to a low energy sequence of a speech signal, said method comprising:
determining a speech energy in a current speech frame;
estimating a speech energy level based on a speech energy in a plurality of speech frames;
if said estimated speech energy level deviates at least by a predetermined amount from a predetermined nominal speech energy level, scaling said determined speech energy in said current speech frame; and
deciding that said current speech frame belongs to a low energy sequence, if said, potentially scaled, frame energy is lower than a predetermined low energy threshold value.

2. The method according to claim 1, wherein said speech energy in said current speech frame is determined by averaging speech energies in a plurality of frequency sub bands in said current speech frame.

3. The method according to claim 1, wherein said speech energy level is determined based only on speech energy in speech frames, in which speech frames a voice activity has been detected.

4. The method according to claim 1, wherein said speech energy level is updated for a respective current speech frame by combining a speech energy level available for a speech frame preceding said current speech frame with said speech energy determined for said current speech frame with variable coefficients, wherein a coefficient for said speech energy determined for a current speech frame may be equal to zero.

5. The method according to claim 4, wherein in case said determined speech energy in said current speech frame is higher than a speech energy in said preceding speech frame, said available speech energy level is weighted with a first coefficient, wherein in case said determined speech energy in said current speech frame is lower than said speech energy in said preceding speech frame, said available speech energy level is weighted with a second coefficient, and wherein said first coefficient is higher than said second coefficient.

6. The method according to claim 4, wherein different coefficients are selected for speech frames at a beginning of a respective speech signal than for speech frames at a later stage.

7. The method according to claim 4, wherein said speech energy level is only updated, in case said updated speech energy level exceeds a background noise estimate for said current speech frame by a predetermined factor.

8. The method according to claim 1, wherein in case said estimated speech energy level exceeds said nominal speech level at least by a predetermined amount, said determined speech energy for said current frame is scaled to a lower value, and wherein in case said estimated speech energy level falls short of said nominal speech level at least by a predetermined amount, said determined speech energy for said current frame is scaled to a higher value.

9. The method according to claim 1, wherein said scaling is performed based on one of a plurality of correction functions, each correction function being valid for another range of speech energy levels.

10. The method according to claim 1, wherein said scaling comprises a multiplication of said speech energy by a selected value and an adding of a selected value.

11. The method according to claim 1, further comprising an encoding of said current speech frame, wherein said current speech frame is encoded with a dedicated low bit rate coding mode, in case said current speech frame is detected to belong to a low energy sequence.

12. The method according to claim 11, wherein said low energy sequence detection is performed one of before an encoding of said current speech frame or during an encoding of said current speech frame.

13. The method according to claim 11, wherein said encoding of said current speech frame is performed in the scope of one of an adaptive multi-rate codec and an adaptive multi-rate wideband codec.

14. An encoding module comprising:
a frame energy detector adapted to determine a speech energy in a current speech frame of a speech signal;
a speech level estimator adapted to estimate a speech energy level based on a speech energy in a plurality of speech frames;
a scaling portion adapted to scale a speech energy in a current speech frame determined by said frame energy detector, if a speech energy level estimated by said speech level estimator deviates at least by a predetermined amount from a predetermined nominal speech energy level; and
a selector adapted to decide that said current speech frame belongs to a low energy sequence, if a, potentially scaled, frame energy provided by said scaling portion is lower than a predetermined low energy threshold value.

15. The encoding module according to claim 14, wherein said frame energy detector is adapted to determine said speech energy in said current speech frame by averaging speech energies in a plurality of frequency sub bands in said current speech frame.

16. The encoding module according to claim 14, wherein said frame energy detector is adapted to determine said speech energy level based only on speech energy in speech frames, in which speech frames a voice activity has been detected.

17. The encoding module according to claim 14, wherein said scaling portion is adapted to scale said determined speech energy for said current frame to a lower value in case said estimated speech energy level exceeds said nominal speech level at least by a predetermined amount, and wherein said scaling portion is adapted to scale said determined speech energy for said current frame to a higher value in case said estimated speech energy level falls short of said nominal speech level at least by a predetermined amount.

18. The encoding module according to claim 14, wherein said scaling portion is adapted to perform said scaling based on one of a plurality of correction functions, each correction function being valid for another range of speech energy levels.

19. The encoding module according to claim 14, wherein said scaling performed by said scaling portion comprises a multiplication of said speech energy by a selected value and an adding of a selected value.

20. The encoding module according to claim 14, further comprising a speech encoder adapted to encode a current speech frame, wherein said current speech frame is encoded with a dedicated low bit rate coding mode, in case said current speech frame is detected to belong to a low energy sequence.

21. An encoding module comprising:
means for determining a speech energy in a current speech frame of a speech signal;
means for estimating a speech energy level based on a speech energy in a plurality of speech frames;
means for scaling a determined speech energy in a current speech frame, if an estimated speech energy level deviates at least by a predetermined amount from a predetermined nominal speech energy level; and
means for deciding that said current speech frame belongs to a low energy sequence, if a, potentially scaled, frame energy is lower than a predetermined low energy threshold value.

22. An electronic device comprising:
a frame energy detector adapted to determine a speech energy in a current speech frame of a speech signal;
a speech level estimator adapted to estimate a speech energy level based on a speech energy in a plurality of speech frames;
a scaling portion adapted to scale a speech energy in a current speech frame determined by said frame energy detector, if a speech energy level estimated by said speech level estimator deviates at least by a predetermined amount from a predetermined nominal speech energy level; and
a selector adapted to decide that said current speech frame belongs to a low energy sequence, if a, potentially scaled, frame energy provided by said scaling portion is lower than a predetermined low energy threshold value.

23. The electronic device according to claim 22, further comprising a speech encoder.

24. The electronic device according to claim 22, wherein said electronic device is one of a wireless communication device or a network element of a wireless communication network.

25. A software program product in which a software code for detecting speech frames belonging to a low energy sequence of a speech signal is stored, said software code realizing the following steps when running in a processing unit of an electronic device:
determining a speech energy in a current speech frame;
estimating a speech energy level based on a speech energy in a plurality of speech frames;
if said estimated speech energy level deviates at least by a predetermined amount from a predetermined nominal speech energy level, scaling said determined speech energy in said current speech frame; and
deciding that said current speech frame belongs to a low energy sequence, if said, potentially scaled, frame energy is lower than a predetermined low energy threshold value.
